(19) United States
(12) Patent Application Publication
(10) Pub. No.: US 2025/0242958 A1
(43) Pub. Date: Jul. 31, 2025

(54) COVERING DEVICE FOR A FILLING STATION AND FILLING STATION HAVING A COVERING DEVICE OF THIS KIND

(71) Applicant: Ampack GmbH, Königsbrunn (DE)

(72) Inventors: Alois Sturm, Friedberg (DE); Alexander Gaab, Aurach (DE); Markus Zimmermann, Landsberg am Lech (DE)

(21) Appl. No.: 18/693,239

(22) PCT Filed: Oct. 5, 2022
(86) PCT No.: PCT/EP2022/077717

§ 371 Date: Mar. 19, 2024

(30) Foreign Application Priority Data
Oct. 5, 2021 (DE) 10 2021 125 824.3

(51) Int. Cl. B65B 43/54; B65B 55/10

(52) U.S. Cl. CPC B65B 43/54; B65B 3/04; B65B 43/44; B65B 43/52; B65B 57/00; B67C 3/005; B65B 2210/06

(57) ABSTRACT

A covering device for a filling station has at least one container transfer housing that forms an accommodating space configured to accommodate a container transfer unit of the filling station, which projects from a closed filling space of the filling station. The container transfer housing has at least one transfer opening for passage of the container into and/or out of the accommodating space. The covering device further includes at least one covering which closes the transfer opening in at last one operation state of the covering. The covering is supported movably at the container transfer housing. The covering device further includes at least one cleaning unit arranged within the container transfer housing and is configured, when the transfer opening is closed by the covering, for an automated cleaning of the accommodating space, and includes at least one sensor element for a detection of at least one position of the covering.

### CROSS REFERENCE TO RELATED APPLICATIONS

This patent application claims the benefit of and incorporates herein by reference the international patent application PCT/EP2022/077717, filed on Oct. 5, 2022, and the German patent application DE 10 2021 125 824.3, filed on Oct. 5, 2021.

### BACKGROUND

From DE 199 20 260 A1, DE 10 2019 104 303 A1, DE 10 2019 214 962 A1 and DE 10 2017 128 363 A1 covering devices for a filling station for a filling of a container are already known, wherein the already-known covering devices comprise at least one container transfer housing that forms an accommodating space configured to accommodate a container transfer unit of the filling station, which projects from a closed filling space of the filling station, the container transfer housing having at least one transfer opening for a passage of the container into and/or out of the accommodating space of the container transfer housing, said covering devices further comprising at least one covering which closes the transfer opening in at least one operation state of the covering, wherein the covering is supported movably at the container transfer housing.

### SUMMARY

The invention is based on a covering device for a filling station for a filling of a container, with at least one container transfer housing that forms an accommodating space configured to accommodate a container transfer unit of the filling station, which projects from a closed filling space of the filling station, the container transfer housing having at least one transfer opening for a passage of the container into and/or out of the accommodating space of the container transfer housing, and with at least one covering which closes the transfer opening in at least one operation state of the covering, wherein the covering is supported movably at the container transfer housing.

It is proposed that the covering device comprises a cleaning unit, which is arranged within the container transfer housing and is configured, when the transfer opening is closed by means of the covering, for an automated cleaning of the accommodating space, and comprises at least one sensor element for a detection of at least one position of the covering. The filling station is in particular configured for a filling of the container with a liquid mass, with a pasty mass and/or with a bulk product. For example, the filling station is configured for a filling of the container with food products, with animal feed, with hygiene articles, with cosmetics, with medical products, or the like. In particular, the filling station, in particular the closed filling space, is configured for a hygienically clean filling of the containers. In particular, the filling station fulfils at least hygiene class II of the German Mechanical Engineering Industry Association (VDMA), preferably hygiene class III (“Hygienic”), hygiene class IV (“UltraClean”) or hygiene class V (“Aseptic”). The container may be embodied as a cup, as a bottle, as a vial, as a pouch, as a shell, or as a box, or may have another shape. In particular, the filling station comprises at least one filling device, in particular at least one filling tube or filling chute, within the closed filling space for a filling of the container. Especially preferentially the filling station comprises a sealing device within the filling space for a sealing of the filled container. The container transfer unit preferably comprises a receiving unit, which is configured to receive an empty container outside the filling space from a container repository that is arranged outside the accommodating space and/or from an operator. The container repository may be realized as part of the covering device or as part of an external container supply device. Preferably the container transfer unit comprises at least one output unit for an output of the filled container, which is in particular arranged outside the accommodating space. In particular, the filling station comprises a transport unit for a transport of the container, in particular starting from the receiving unit, through the closed accommodating space, and in particular to the output unit.

The covering device is in particular configured to close the accommodating space, in particular together with the container transfer unit that is at least partly arranged therein, during at least one operation state of the covering device, and to make the accommodating space accessible from an outside during at least one further operation state of the covering device. In particular, the covering is configured to close or to open the transfer opening, preferably depending on an operation state of the covering device and/or of the filling station. For example, the covering device comprises the transfer housing for an accommodation of the receiving unit or of the output unit. The covering device optionally comprises a further transfer housing, in particular with a further covering, for an accommodation of the output unit or the receiving unit, in particular of that unit of the container transfer unit which is not arranged in the transfer housing. The container transfer housing comprises at least one transfer wall, at which the transfer opening is arranged. In particular, the transfer wall delimits the transfer opening. Preferably the transfer opening is arranged in a single wall of the container transfer housing. In particular, this wall delimits the transfer opening completely. Alternatively, the transfer opening is arranged so as to be distributed over several walls. In particular, in the alternative implementation the several walls delimit the transfer opening. The transfer wall may be realized planar or curved. The transfer wall in particular has an outer surface facing away from the accommodating space, an inner surface facing towards the accommodating space and a channel wall that delimits a breakthrough through the transfer wall. The breakthrough in particular forms the transfer opening, wherein because of at least one insert element of the covering device that is arranged in the breakthrough, for example an edge reinforcement, a proofing ring, a guide rail for the covering or the like, a maximal aperture width of the transfer opening may be smaller than a maximal aperture width of the breakthrough.

A designated container transfer direction along which a container is transported through the transfer opening, preferably runs at least substantially perpendicular to the outer surface and/or the inner surface of the transfer wall. The container transfer housing preferably defines a designated transport direction along which the container is transported within the accommodating space. The transport direction may run at least substantially perpendicular or at least substantially parallel to the container transfer direction. Preferably, in an implementation of the container transfer housing for an accommodation of the receiving unit, the transport direction runs at least substantially perpendicular to the container transfer direction. In an, in particular alternative, implementation of the container transfer housing for an accommodation of the output unit, the transport direction may run at least substantially perpendicular or at least substantially parallel to the container transfer direction. In particular, the container transfer housing has along the transport direction a transport opening, which is configured to accommodate the container transfer unit. The transport opening and the transfer opening are preferably arranged on two different walls of the container transfer housing, which in particular face away from each other. The transfer opening preferably has a maximal aperture length parallel to the transport direction. The container transfer direction may run perpendicular or parallel to the maximal aperture length. The transfer opening preferably has a maximal aperture breadth which is at least substantially perpendicular to the transport direction and to the container transfer direction. The maximal aperture length and the maximal aperture breadth may be of the same dimension or of different dimensions. In particular, the maximal aperture width may be equal to the maximal aperture length and/or to the maximal aperture breadth. The maximal aperture breadth is preferably larger than a multifold of a maximal extent of the container perpendicular to the container transfer direction during a transport of the container along the container transfer direction through the transfer opening. In particular, the multifold of the maximal extent of the container is at least twice, preferably at least four times, particularly preferably at least six times, the maximal extent of the container. In particular, the transfer opening is configured to let several containers pass through the transfer opening, and in particular feed them to the container transfer unit, at the same time or with a temporal overlap.

The term “substantially perpendicular” is here in particular meant to define an orientation of a direction relative to a reference direction, wherein the direction and the reference direction, in particular viewed in a projection plane, include a 90° angle and the angle has a maximal deviation of in particular less than 8°, advantageously less than 5° and especially advantageously less than 2°. “Substantially parallel” is here in particular to mean an orientation of a direction relative to a reference direction, in particular in a plane, wherein the direction has a deviation from the reference direction that is in particular smaller than 8°, advantageously smaller than 5° and especially advantageously smaller than 2°

The covering may be arranged at the outer surface, at the inner surface and/or within the breakthrough of the transfer wall. The covering is preferably realized by a single component, for example by a plate, by a sheet, by a tarpaulin, or the like. Alternatively, the covering comprises several individual components, which are in particular structurally identical, for example lamellae, strips or plates, which are arranged at one another such that they are movable relative to one another, in particular via hinges, straps, ropes, wires or the like. Preferably the covering is made of metal, for example of stainless steel or of aluminum, alternatively of a synthetic material, for example of polyphenylene sulfide (PPS), of polyphthalamide (PPA), of polyethylene terephthalate (PET), of polyether ether ketone (PEEK) or the like, or of a different material that is deemed expedient by someone skilled in the art. The covering is preferably arranged at the container transfer housing in a form-fitting manner. In particular, the covering is arranged at the container transfer housing such that it is non-destructively detachable from the container transfer housing only with (a) tool(s).

In particular, the covering device comprises a bearing unit, by means of which the covering is supported such that it is displaceable relative to the container transfer housing along a straight, bent and/or curved guide path and/or is pivotable or rotatable relative to the container transfer housing around an axis. The bearing unit may be realized as an individual component or assembly group of the container transfer housing or as a separate component or as a separate assembly group that is fastened on the container transfer housing. Preferably a guide path along which the covering is movable extends at least substantially parallel to the outer surface and/or to the inner surface of the transfer wall. Particularly preferentially the guide path along which the covering is movable extends at least substantially parallel to the maximal opening length of the transfer opening. Alternatively, the guide path along which the covering is movable extends at least substantially parallel to the maximal opening breadth of the transfer opening. Preferably, viewed along the container transfer direction, in a state when the covering closes the transfer opening, the covering covers at least a large portion of a cross section area of the transfer opening that extends perpendicular to the container transfer direction. A “large portion” is in particular to mean more than 75%, preferably more than 90%, particularly preferably more than 95% of a maximal reference dimension, in particular of the cross section area of the transfer opening. Optionally, in the state when the covering closes the transfer opening, the covering extends beyond the transfer opening.

The covering preferentially has a flat base body. In different operation states, the covering may assume different shapes by deformation, in particular bending and/or winding up, of the base body. In particular the covering has, in a spread, in particular wound-off state, a maximal longitudinal extent, a maximal width that is at least substantially perpendicular to the maximal longitudinal extent, and a material thickness that is at least substantially perpendicular to the maximal longitudinal extent and to the maximal width. Preferentially, at least in a state when the covering closes the transfer opening, the maximal longitudinal extent of the covering is arranged at least substantially parallel to the maximal aperture length of the transfer opening. The maximal width of the covering is preferably arranged at least substantially parallel to the maximal aperture breadth of the transfer opening.

Preferably, at least in a state when the covering closes the transfer opening, the material thickness of the covering is arranged at least substantially parallel to the container transfer direction. The maximal length of the covering and the maximal width of the covering are preferably in each case at least 10 times, preferably at least 20 times, in particular more than 100 times, as great as the material thickness of the covering. The maximal longitudinal extent and the maximal width of the covering may be equal in size or different in size, wherein a difference between the maximal width and the maximal length is preferably smaller than a factor of 20, in particular smaller than a factor of 10.

Preferably the covering closes the transfer opening at least in splash-proof fashion with regard to a liquid hitting the covering within the accommodating space at an angle between 30° and 90°, preferably at any angle. Optionally the covering device comprises, at the covering and/or within the breakthrough of the transfer wall, a proofing for a closure of the transfer opening by the covering, which is—in particular up to at least 1 m—watertight and/or dust-tight. Preferably the covering device comprises a storage unit, in which the covering is at least partly arranged when the covering at least partly closes the transfer opening. The storage unit may be realized identically with the container transfer housing. In particular if the covering is arranged on the inner surface of the transfer wall, or may be realized as a separate unit which is preferably fixed at the container transfer housing, in particular if the covering is arranged on the outer surface of the transfer wall. For example, the storage unit may be embodied as a frame, as a housing, as a guide rail unit, or the like.

The implementation of the covering device according to the invention allows closing and opening the accommodating space in an advantageously flexible manner and with advantageously small effort. In particular, an equipment cart for intermediate storage of a removable covering can be dispensed with. It is in particular possible to keep the accommodating space advantageously clean, with advantageously small effort. In particular, a risk of an operator error, like for example deposition of a removable covering in a contaminated region, can be kept advantageously low.

It is furthermore proposed that the covering device comprises at least one winding shaft, which the covering is wound on in at least one operation state of the covering. The winding shaft is preferably arranged within the storage unit. In particular, the bearing unit comprises at least one radial bearing in which the winding shaft is supported. The bearing unit is preferably arranged in or at the storage unit. In particular, the winding shaft is configured to wind the covering within the storage unit. A longitudinal axis of the winding shaft is preferably aligned at least substantially perpendicular to the transport direction, and in particular at least substantially perpendicular to the container transfer direction. Preferably the winding shaft is arranged on a side of the container transfer housing that faces away from the transport opening. The covering device preferably comprises a spring element, which is arranged on the winding shaft for an automatic rotation of the winding shaft and is in particular configured for automatic winding of the covering onto the winding shaft. In an implementation with an advantageously low number of components, the covering itself forms the spring element, which is embodied as a helical spring, and which is in particular relaxed in an open state of the transfer opening and is tensioned by the covering for a closing of the transfer opening. Alternatively, the spring element is realized independently from the covering. Alternatively or additionally to the spring element, the covering device comprises at least a winding shaft motor for an automatic rotation of the winding shaft. Alternatively or additionally, the covering device comprises a handwheel for a manual rotation of the winding shaft. Alternatively, the winding shaft is realized without a drive and is rotated passively, in particular only by traction or pressure of the covering. Alternatively to a winding shaft, the storage unit comprises guide rails, which run along the outer surface or the inner surface away from the transfer opening. As an alternative to the winding shaft, the covering is realized as a telescopic covering with at least two telescope segments which are displaceable into each other. The implementation according to the invention allows storage of the covering in an advantageously compact manner.

The cleaning unit preferably comprises at least one spray head, in particular several spray heads, for spraying at least one cleaning liquid. The cleaning unit is in particular configured to carry out a cleaning-in-place (CIP) method. For example, a cleaning unit may be configured to distribute one, several or all of the following examples of cleaning fluids in the accommodating space: water, in particular for pre-flushing and/or for flushing out other cleaning liquids, an alkaline agent, in particular soda lye, an acid, a disinfection agent, ultrapure water, in particular for flushing out the disinfection agent, and/or purified water. The at least one spray head is preferably arranged on a side of the accommodating space facing away from the transfer opening or situated opposite the transfer opening. In particular, the at least one spray head and the transfer opening are configured to be arranged on different sides of the container transfer unit. Preferably the cleaning unit comprises a distribution system for a distribution of the cleaning liquid to several spray heads of the cleaning unit. The cleaning unit is in particular configured for cleaning the accommodating space and/or the container transfer unit. Preferably the container transfer housing comprises at least one outlet for discharging the used cleaning liquid. The implementation according to the invention allows carrying out a cleaning of the accommodating space in an advantageously efficient, automated and quick manner and with advantageously low damaging to an environment. In particular, the covering device is capable of keeping an amount of cleaning liquid leaking from the accommodating space advantageously small.

The sensor element is preferably configured at least to detect that the covering is in a closure position, in which the covering closes the transfer opening. Additionally or alternatively, the sensor element or a further sensor element of the covering device is configured to detect the covering being in a transfer position, in which the transfer opening is maximally open or in which at least one path for the container from the container repository into the accommodating space is released, in particular not blocked, by the covering. In particular, in the transfer position of the covering a greater portion of the covering is within the storage unit than in the closure position. Optionally, the sensor element and/or the further sensor element or a sensor unit with a plurality of sensor elements of the covering device are/is configured to detect one or several intermediate positions of the covering between the closure position and the transfer position. The sensor element and/or the further sensor element may be realized, for example, as a light barrier, as a distance sensor, as a proximity switch, or the like, for a detection of a position of the covering. Alternatively, the sensor element is realized as an angle transmitter and is arranged at the winding shaft in order to detect rolling-up or rolling-off of the covering. Alternatively, the sensor element is realized as a mechanical switch, which is actuated by the covering in the position that is to be detected. Alternatively, the sensor element has along the transfer opening resistive electrical contacts which are electrically connected by the covering, such that a resulting electrical resistance of the electrodes depends on the position of the covering. The implementation according to the invention advantageously allows controlling an operation of the cleaning unit and/or of the filling station depending on a position of the covering.

Beyond this it is proposed that the container transfer housing comprises at least one guide rail in or on which the covering is arranged. Preferably the container transfer housing comprises at least two guide rails, which are arranged at least substantially parallel to each other. In particular, the guide rails define the aforementioned guide path. Preferably a longitudinal axis of the at least one guide rail is at least substantially parallel to the maximal opening length, alternatively to the maximal opening breadth, of the transfer opening. The at least one guide rail may be arranged on the outer surface, on the inner surface and/or within the breakthrough of the transfer wall. Preferably the at least one guide rail has a groove in which the covering is arranged in displaceable fashion. Alternatively, the covering device comprises a groove which a rib of the at least one guide rail engages in. In an advantageously most cost-efficient implementation, the at least one guide rail is made of a synthetic material, in particular of PPA, PPS, PET, PEEK or the like. Alternatively, the at least one guide rail is made of metal, in particular of stainless steel and/or aluminum. Preferably the at least one guide rail extends at least over a large portion of the maximal aperture length or of the maximal aperture breadth. Preferably the guide rail comprises at least one abutment element, which secures the covering on the guide rail in a form-fitting manner along the longitudinal axis of the guide rail, and in particular defines the transfer position. Preferably an end, in particular the abutment element, of the at least one guide rail is arranged at the storage unit or projects into the storage unit. Alternatively, the at least one guide rail and/or the abutment element is arranged spaced apart from the storage unit. By the implementation according to the invention, a risk of inaccurate or oblique arrangement of the covering at the transfer opening can be kept advantageously low. In particular, it is possible to keep a risk of insufficient proofing of the transfer opening can be kept advantageously low. In particular, the closure position and the transfer position are assumed by the covering in an advantageously reliable manner.

It is also proposed that the covering comprises a closing strip which is configured, in at least one operation state of the covering, to close a transport opening, in particular the aforementioned transport opening, of a station housing of the filling station which delimits the filling space. A longitudinal axis of the closing strip is preferably arranged at least substantially perpendicular to the transport direction. In particular, the longitudinal axis of the closing strip is arranged at least substantially perpendicular to the maximal opening length. Preferably the closing strip and the storage unit, in particular the winding shaft, are arranged at different ends of the covering. The closing strip preferably closes the transport opening at least when the covering is in the closure position. Preferably the closing strip is arranged spaced apart from the transport opening, at least when the covering is in the transfer position. Preferably a maximal transverse extent of the closing strip perpendicular to the longitudinal axis of the closing strip is smaller than the maximal aperture length of the transfer opening and/or smaller than a maximal longitudinal extent of the closing strip along the longitudinal axis, in particular at least 5 times smaller, preferentially at least 10 times smaller. The transport opening is in particular configured for transporting the container into the filling space without contacting the station housing. Alternatively to a closing strip, the covering has a maximal width and material thickness perpendicular to the transport direction, which closes the transport opening in an accurately fitting manner. The implementation according to the invention allows advantageously tight closing of the filling space. It is in particular possible to do without an extra mechanism for a proofing of the filling space.

It is moreover proposed that the covering device comprises a container repository, in particular the aforementioned container repository, which is arranged outside the container transfer housing, for a positioning of the containers at the container transfer unit, wherein the covering is in at least one operation state arranged between the container repository and the container transfer housing. The container repository preferably comprises at least one drop chute, in particular several drop chutes arranged in parallel, for providing the container, in particular several containers simultaneously. In particular, the container repository comprises at least one holding element for a holding of the container that is the next to be forwarded to the receiving unit. Preferably the container repository arranged, in particular screwed, on the container transfer housing such that it is non-destructively detachable. Preferably the at least one drop chute of the container repository is oriented along the container transfer direction towards the transfer opening. In particular, the container repository comprises at least one spacer element, by means of which an end of the drop chute that faces towards the container transfer housing, in particular the holding element, is arranged spaced apart from the transfer wall. In particular, the spacer element is at least sufficiently long such that a container held in the drop chute by the holding element has a distance from the transfer wall. In particular, the covering is in the closure position arranged between the drop chute and the transfer opening. In particular, the spacer is longer than the material thickness of the covering. Due to the implementation according to the invention, the covering can be moved into the closure position and into the transfer position without requiring removal of the container repository. In particular, in case of a format change of the container, the covering can be moved into the closure position before the container repository is exchanged. It is in particular possible to carry out an exchange of the container repository in an advantageously clean manner. In particular, a closing of the transfer opening, for example for a cleaning of the accommodating space, can be carried out without demounting the container repository.

Furthermore, it is proposed that the covering device comprises at least one drive unit, which comprises at least one actuation element for a manual moving of the covering. Preferably the drive unit is configured to move, in particular pull, the covering out of the transfer position into the closure position. Alternatively or additionally, the drive unit is configured to move the covering from the closure position into the transfer position. Preferentially the covering is moved from the closure position into the transfer position by the spring element. The drive unit and the storage unit are preferably arranged on different sides of the transfer opening. Preferably the actuation element is embodied as a handwheel. In particular, the drive unit comprises a winch, which is connected to the covering via at least one rope, in particular a wire rope or a synthetic-fiber rope, via a chain, or via a strap or the like. In particular, the handwheel is connected to the winch mechanically for a rotation of the winch. Alternatively, the drive unit comprises a rod, in particular a telescope rod, which is retractable and deployable by means of the actuation element and is fixed to the covering. Alternatively, the actuation element is realized as a handle that is arranged directly at the covering. The implementation according to the invention advantageously allows operating the covering independently from an operation of the filling station. In particular, maintenance work can be carried out advantageously simply.

Beyond this it is proposed that the covering device comprises at least one drive unit, in particular the aforementioned drive unit, comprising at least one motor, in particular electromotor, for an automated movement of the covering. A drive shaft of the motor is in particular connected to the winch for a rotation of the winch. In an implementation of the drive unit with a motor and a handwheel, the drive unit preferably comprises at least one coupling unit for a coupling or uncoupling of the drive shaft of the motor and the winch. In an implementation of the drive unit with a motor and a handwheel, the drive unit preferably comprises at least one further coupling unit for a coupling or uncoupling of the handwheel and the winch. Preferentially the covering device comprises the motor of the drive unit or the winding shaft motor for a movement of the covering. Alternatively, the covering device comprises the motor of the drive unit and the winding shaft motor for a movement of the covering. Preferentially, for a movement of the further covering the covering device comprises a further drive unit, which is independent from the drive unit and has a further motor, which can be operated independently from the motor. Alternatively, the drive unit comprises a gear unit that couples the covering and the further covering with the same motor. With the implementation according to the invention, it is possible to do without a presence of an operator in a proximity of the transfer opening. In particular, a risk of dust, hair or the like entering the accommodating space can be kept advantageously low. Moreover, a risk of faulty operation, in particular unhygienic handling, of the covering can be kept advantageously low.

It is also proposed that the covering device comprises at least one control or regulation unit, the control or regulation unit being configured for a temporal coordination of a movement of the covering and an operation and/or a cleaning, in particular sterilization, of the filling station. The control or regulation unit in particular comprises a control electronics unit. The control electronics unit preferably comprises a processor unit, a memory unit and an operation program stored in the memory unit. The control or regulation unit is in particular configured to send controlling signals to the drive unit, to the cleaning unit and/or to the filling station. The control or regulation unit is in particular configured to query sensor signals from the sensor element. The control or regulation unit may be realized as part of a central controlling of the filling station or as an independent electronics component, optionally having its own electronics housing. Preferably the control or regulation unit comprises at least one data interface for a communication with the filling station, in particular a central controlling of the filling station, and/or with an operator of the filling station. The control or regulation unit is preferentially configured to query an operation state of the filling station via the data interface. In particular, the control or regulation unit is configured, in the course of putting the filling station into operation, to make the drive unit or the winding shaft motor move the covering into the transfer position or at least to release a blocking of the covering in the closure position. In particular, the control or regulation unit is configured, in the course of shutting down of the filling station, of a pausing of the filling station, of a cleaning of the filling station and/or of a sterilization of the filling station, to make the drive unit move the covering into the closure position and in particular to block the covering there. Preferably the control or regulation unit is configured, in a cleaning and/or sterilization of the filling station, to activate the cleaning unit. Preferably the control or regulation unit is configured to activate the cleaning unit only if the covering is in the closure position. Preferably the control or regulation unit is configured to deactivate the cleaning unit after termination of a cleaning program that is stored in the memory unit or in the case of a premature movement of the covering out of the closure position. Optionally, the covering device comprises a mechanical or electromagnetic locking mechanism, which prevents manual moving of the covering at least during the cleaning program. In particular, the control or regulation unit is configured to evaluate the sensor signal from the sensor element in order to determine a position of the covering. Optionally the control or regulation unit accepts an operator's orders for a moving of the covering and/or for an activation/deactivation of the cleaning unit independently from an operation state of the filling station. Preferably the control or regulation unit queries the operator's orders via the data interface. Alternatively or additionally, the control or regulation unit comprises at least one input element, in particular a button, a touchscreen, a control dial or the like, for a manual input of an order by the operator. The implementation according to the invention allows a movement of the covering being advantageously coupled with the operation of the filling station and/or of the cleaning unit. In particular, a risk of a missing covering or of a faulty positioning of the covering can be kept advantageously low during a cleaning process and/or during operation of the filling station.

Moreover, a filling station for a filling of a container is proposed, comprising at least one covering device according to the invention. The filling station in particular comprises the station housing that surrounds the filling space, the station housing having at least one container entry and a container exit. Optionally, the station housing comprises at the container entry and/or at the container exit a sluice device for preventing dust from entering into the filling space. The sluice device may be, for example, a lamellae curtain, a suction, a blower, or the like. Preferably the filling station comprises the transport unit for a transport of the container through the filling space. The transport unit in particular comprises a conveying system, for example a belt conveying system and/or a modular-belt conveying system. The transport unit in particular projects from the filling space, in particular from the sluice device, through the container entry and/or through the container exit. In particular, the portion/s of the transport unit which project/s from the filling space form/s at least part of the container transfer unit. Preferably the container transfer housing of the covering device, and optionally the further container transfer housing of the covering device, surround/s the container transfer unit that is arranged outside the filling space. The container transfer housing is preferably fastened to the station housing. Optionally the container transfer housing is realized integrally with the station housing or has at least one wall which also forms a wall of the station housing. The filling space and the accommodating space are in particular separated from each other by at least one intermediate wall, wherein the transport opening, respectively the container entry or the container exit, is arranged in this intermediate wall. The intermediate wall may be formed by the station housing and/or by the container transfer housing. In particular, the filling station comprises at least the filling device within the closed filling space for a filling of the container. Particularly preferably the filling station comprises a sealing device within the filling space for a sealing of the filled container. In particular, the filling station comprises at least a central controlling for a synchronization, by means of the transport unit, of a movement of the container with the filling device, the sealing device and/or the container repository. Preferably the filling station comprises at least one operating element for an operation of the filling station by an operator, for example a button, a touchscreen, a control dial, or the like. Preferably the filling station comprises at least one data interface for a communication with the control or regulation unit of the covering device, in particular for a forwarding of orders, input by an operator via the operating element, to the control or regulation unit. The implementation according to the invention allows providing a filling station which achieves an advantageously high hygiene class and whose accommodating spaces outside the filling space are accessible with advantageously little effort.

The covering device according to the invention and/or the filling station according to the invention shall here not be limited to the application and implementation described above. In particular, in order to fulfill a functionality that is described here, the covering device according to the invention and/or the filling station according to the invention may comprise a number of individual elements, components and units that differs from a number given here. Moreover, with regard to the value ranges given in this disclosure, values situated within the limits mentioned shall also be considered as disclosed and as applicable according to requirements.

### BRIEF DESCRIPTION OF THE DRAWINGS

Further advantages will become apparent from the following description of the drawings. In the drawings two exemplary embodiments of the invention are illustrated. The drawings, the description and the claims contain a plurality of features in combination. Someone skilled in the art will purposefully also consider the features separately and will find further expedient combinations.

It is shown in:

FIG. 1 a schematic illustration of a filling station according to the invention,

FIG. 2 a schematic illustration of a covering device according to the invention in an open state,

FIG. 3 a schematic illustration of the covering device according to the invention in a closed state, and

FIG. 4 a schematic illustration of an alternative implementation of a covering device according to the invention.

### DETAILED DESCRIPTION

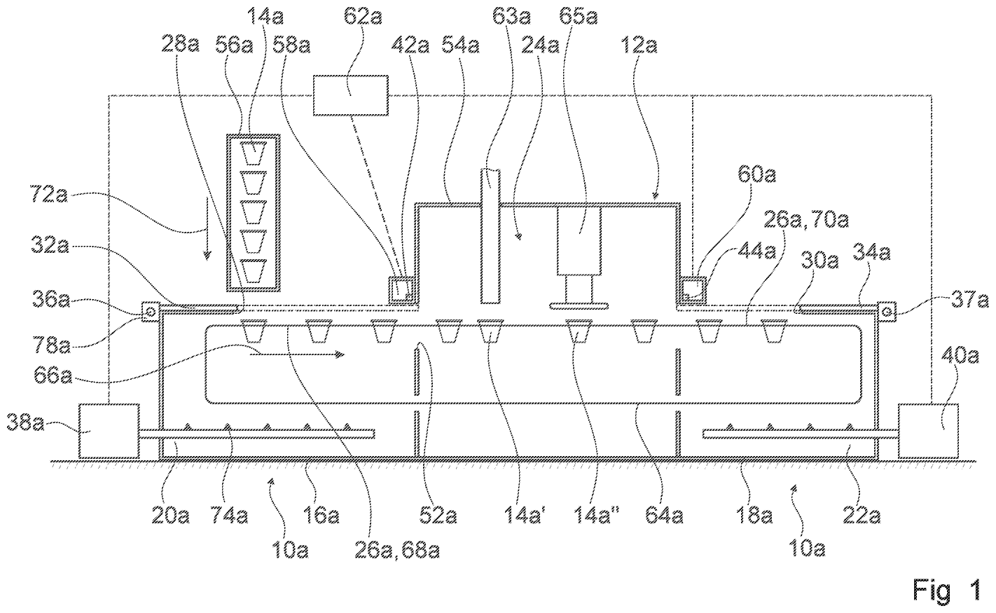

FIG. 1 shows a filling station 12a. The filling station 12a is configured for a filling of a container 14a. The filling station 12a comprises at least one covering device 10a. The filling station 12a in particular comprises a station housing 54a. The station housing 54a preferably includes a filling space 24a of the filling station 12a. The filling space 24a and the station housing 54a are in particular realized for a clean filling of the container 14a. Preferably, the filling station 12a comprises in the filling space 24a at least one filling device 63a, in particular a filling tube, for a filling of the container 14a′. The filling station 12a comprises in the filling space 24a preferably at least one sealing device 65a for a sealing of the filled container 14a″. The filling station 12a in particular comprises a transport unit 64a. The transport unit 64a is preferably embodied as a modular-belt conveying system. In particular, the transport unit 64a is configured to transport the empty container 14a into the filling space 24a along a transport direction 66a. In particular, the transport unit 64a is configured to transport the filled, in particular sealed, container 14a′, 14a″ out of the filling space 24a along the transport direction 66a or along a further transport direction. In particular, the transport unit 64a projects beyond the filling space 24a. The filling station 12a in particular comprises a container transfer unit 26a. The container transfer unit 26a preferably comprises a receiving unit 68a for a transfer of the empty container 14a to the transport unit 64a. Preferably the container transfer unit 26a comprises an output unit 70a for a transfer of the filled, in particular sealed, container 14a′, 14a″ from the transport unit 64a, for example, to an external conveying system. The portion of the transport unit 64a that projects from the filling space 24a against the transport direction 66a in particular forms the receiving unit 68a. The portion of the transport unit 64a that projects from the filling space 24a in the direction of the transport direction 66a or of the further transport direction preferably forms the output unit 70a.

The covering device 10a comprises at least one container transfer housing 16a. The container transfer housing 16a forms an accommodating space 20a. The accommodating space 20a accommodates the container transfer unit 26a of the filling station 12a, in particular the receiving unit 68 of the filling station 12a, that projects from the closed filling space 24a of the filling station 12a. The container transfer housing 16a comprises at least one transfer opening 28a for a passage of the container 24a into the accommodating space 20a of the container transfer housing 16a. The further container transfer housing 18a comprises at least one further transfer opening 30a for a passage of the container 14a into the accommodation space 22a of the container transfer housing 18a. The covering device 10a comprises at least one covering 32a, which closes the transfer opening 28a in at least one operation state of the covering 32a. The covering 32a is supported movably on the container transfer housing 16a.

The covering 32a is preferably supported so as to be movable at least substantially parallel to the transport direction 66a. Preferentially the covering 32a is arranged on an outer face of a transfer wall of the container transfer housing 16a, and is in particular movable along this outer face. In particular, the transfer opening 28a is arranged in the transfer wall. By way of example, the covering 32a is embodied as a sheet or as a metal foil. In FIG. 1 the covering 32a is in particular shown in a transfer position, in which the transfer opening 28a can be passed by the container 14a. The covering 32a is in particular movable in such a way that it can be brought into a closure position. In FIG. 1 the closure position of the covering 32a is indicated by dashed lines. In the closure position the covering 32a preferably closes the transfer opening 28a. The transfer opening 28a in particular defines a container transfer direction 72a, which runs at least substantially perpendicular to the outer face of the transfer wall. For an operation of the filling station 12a, the container transfer direction 72a is preferably configured to be aligned at least substantially parallel to the vertical.

The covering device 10a comprises a container repository 56a, which is arranged outside the container transfer housing 16a, for a positioning of the containers 14a at the container transfer unit 26a, in particular at the receiving unit 68a. The container repository 56a preferably comprises at least one drop chute, which is configured for guiding the container 14a along the container transfer direction 72a and for transferring the container 14a to the container transfer unit 26a. An end of the drop chute that faces towards the container transfer unit 26a is preferably arranged spaced apart from the container transfer housing 16a. The covering 32a is in at least one operation state arranged between the container repository 56a, in particular the drop chute, and the container transfer housing 16a. The covering 32a is, in particular in the closure position, arranged between the container repository 56a, in particular the drop chute, and the container transfer housing 16a. Preferably, the covering 32a exposes in the transfer position at least such a portion of the transfer opening 28a that the container 14a can be transported from the container repository 56a along the container transfer direction 72a through the transfer opening 28a without contacting the covering 32a. The container repository 56a is in particular configured to drop the container 14a onto the container transfer unit 26a along the container transfer direction 72a.

The covering device 10a preferably comprises a storage unit 78a. The storage unit 78a is in particular configured to receive at least part of the covering 32a when the covering 32a is in the transfer position. The storage unit 78a is here, for example, realized as an independent housing arranged, in particular fixed, on an outer face of the container transfer housing 16a. In particular, the storage unit 78a is arranged on a wall of the container transfer housing 16a that differs from the transfer wall. The covering device 10a comprises at least one winding shaft 36a which the covering 32a is wound on in at least one operation state of the covering 32a. The winding shaft 36a is preferably supported on or in the storage unit 78a. In particular, the winding shaft 36a is configured to wind the covering 32a within the storage unit 78a. The covering device 10a preferably comprises at least one spring element, in particular a helical spring, for rotating the winding shaft 36a. The spring element is in particular configured to pull the covering 32a from the closure position into the transfer position. Particularly preferably the covering 32a itself forms the spring element. The winding shaft 36a, in particular together with the storage unit 78a, is preferably arranged on a side of the container transfer housing 16a that faces way from the filling space 24a.

The covering device 10a comprises at least one drive unit 58a. The drive unit 58a is in particular configured for moving the covering 32a from the transfer position into the closure position, in particular against a reset force generated by the spring element. The drive unit 58a comprises at least a motor for an automated movement of the covering 32a. The drive unit 58a preferably comprises a winch, which is connected to a drive shaft of the motor. In particular, the drive unit 58a is configured to pull the covering 32a into the closure position by means of wire ropes or the like, and in particular to block the covering 32a in the closure position. Preferably, for a displacement of the covering 32a into the transfer position, the drive unit 58a is configured at least for loosening a blocking of the covering 32a, and optionally for applying a traction force on the covering 32a that is directed against the reset force of the spring element, the traction force being kept smaller than the reset force. The drive unit 58a is in particular arranged on a side of the container transfer housing 16a that faces towards the filling space 24a.

The covering device 10a comprises at least one sensor element 42a for a detection of at least one position of the covering 32a. By way of example, the sensor element 42a is here embodied as a contactless, in particular capacitive or inductive, proximity sensor. By way of example, the sensor element 42a is configured to detect if the covering 32a is situated in the closure position. In particular, the sensor element 42a is arranged on a side of the container transfer housing 16a that faces towards the filling space 24a. Optionally, the sensor element 42a is arranged on a wall of the transfer wall that delimits the transfer opening 28a.

The covering device 10a comprises at least one cleaning unit 38a, which is arranged within the container transfer housing 16a. The cleaning unit 38a in particular comprises several spray heads 74a for spraying a cleaning liquid within the accommodating space 20a. The cleaning unit 38a and the transfer opening 28a are preferably arranged on different sides of the container transfer unit 26a. When the transfer opening 28a is closed by means of the covering 32a, the cleaning unit 38a is configured for an automated cleaning of the accommodating space 20a. The covering device 10a comprises at least one control or regulation unit 62a. The control or regulation unit 62a is configured for a temporal coordination of a movement of the covering 32a and an operation and/or a cleaning, in particular sterilization, of the filling station 12a. In particular, the control or regulation unit 62a makes the drive unit 58a move the covering 32a into the closure position when the control or regulation unit 62a has received an order to clean the accommodating space 20a. The order for cleaning may be received, for example, from an operator, from a central controlling of the filling station 12a or may be triggered by a timer of the control or regulation unit 62a. Preferably the control or regulation unit 62a enquires from the sensor element 42a whether the covering 32a is in the closure position. In particular, the control or regulation unit 62a only makes the cleaning unit 38a let the cleaning liquid enter the accommodating space 20a via the spray heads 74a if the covering 32a is in the closure position. In particular, when the filling station 12a is put into operation, the control or regulation unit 62a makes the drive unit 58a move the covering 32a or permit the covering 32a to move from the closure position into the transfer position. Optionally the covering device 10a comprises a transfer sensor element which detects whether the covering 32a is in the transfer position. Alternatively, in the control or regulation unit 62a a time is stored which the covering unit 32a requires for changing from the closure position into the transfer position. In particular, as soon as the covering 32a is in the transfer position, the control or regulation unit 62a emits a release signal to the central controlling that a filling program for a filling of the container 14a can be executed.

The covering device 10a comprises at least one further container transfer housing 18a. The further container transfer housing 18a in particular forms a further accommodating space 22a. The further accommodating space 22a in particular accommodates the output unit 70a. The further container transfer housing 18a comprises at least one further transfer opening 30a for a passage of the filled, in particular sealed container 14′, 14″ from the further accommodating space 22a of the further container transfer housing 18a. The covering device 10a comprises at least one further covering 34a, which closes the further transfer opening 30a in at least one operation state of the further covering 34a. The further covering 34a is supported movably on the further container transfer housing 18a.

The further covering 34a and the further container transfer housing 18a may be realized structurally identical to or different from the covering 32a, respectively the container transfer housing 16a. The output unit 70a may be configured, for example, for transferring the filled, in particular sealed container 14′, 14″ to an external belt conveyor, or for providing the filled, in particular sealed container 14′, 14″ to an external gripper device or an external suctioning device. In particular, the further transfer opening 30a may be arranged on a ceiling wall, a sidewall or a bottom wall of the further container transfer housing 18a. Except for an arrangement and shaping of the further transfer opening 30a, construction details of the further covering 34a and of the further container transfer housing 18a preferably correspond to construction details of the covering 32a, respectively of the container transfer housing 16a. In particular, the covering device 10a comprises at least one further winding shaft 37a for a rolling up of the further covering 34a. The covering 34a is preferably rolled up at least partly in a further storage unit 78a of the covering device 10a. Preferably the covering device 10a comprises a further drive unit 60a for a movement of the further covering 34a. Preferably the drive unit 58a and the further drive unit 60a are actuatable independently from each other. Preferably the covering device 10a comprises a further sensor element 44a for a detection of a position of the further covering 34a. Preferably the covering device 10a comprises a further cleaning unit 40a, which is arranged in the further accommodating space 22a. The cleaning unit 38a and the further cleaning unit 40a are preferably actuatable independently from each other. Preferably the cleaning unit 38a and the further cleaning unit 40a are connected to a common cleaning liquid source, in particular to a common collection reservoir of the covering device 10a. Preferably the control or regulation unit 62a is configured for checking the covering 32a and the further covering 34a. Alternatively, the covering device 10a comprises a further control or regulation unit, which specifically synchronizes a movement of the further covering 34a with an operation and/or a cleaning, in particular sterilization, of the filling station 12a.

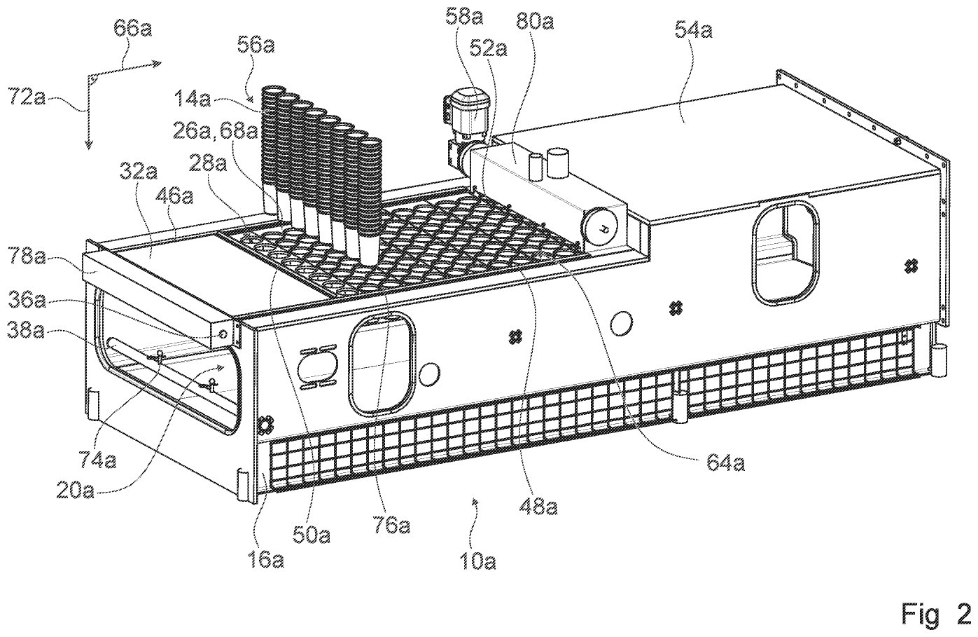

FIG. 2 shows the portion of the covering device 10a that is arranged at the receiving unit 68a in a perspective illustration. For better overview, the container repository 56a is depicted only by stacks of containers 14a, which are situated in several parallel drop chutes of the container repository 56a. The container transfer unit 26a in particular comprises a plurality of perforated plates 76a. The perforated plates 76a in particular have several holes, in the present case by way of example eight holes, which are arranged in rows perpendicular to the transport direction 66a and are configured for a suspending of respectively one container 14a. The container repository 56a in particular comprises a plurality of drop chutes corresponding to the holes of the perforated plates 76a.

The container transfer housing 16a in particular comprises two guide rails 46a, 48a which the covering 32a is arranged in. The covering 32a is here in particular in the transfer position. The guide rails 46a 48a in particular run at least substantially parallel to the transport direction 66a. By way of example, the guide rails 46a, 48a have, in a plane perpendicular to the transport direction 66a, a U-shaped profile in which the covering 32a is suspended. The guide rails 46a, 48a in particular extend from the storage unit 78a to a transport opening 52a of the station housing 54a. The transport opening 52a is here exemplarily arranged at a sluice device 80a, in particular a suctioning device, of the filling station 12a. The drive unit 58a and the sluice device 80a are here arranged partially integrally with each other, in particular for an advantageously compact construction. In particular, the drive shaft of the motor of the drive unit 58a is supported on a housing of the sluice device 80a. Alternatively, the drive unit 58a may be realized independently from the sluice device 80a.

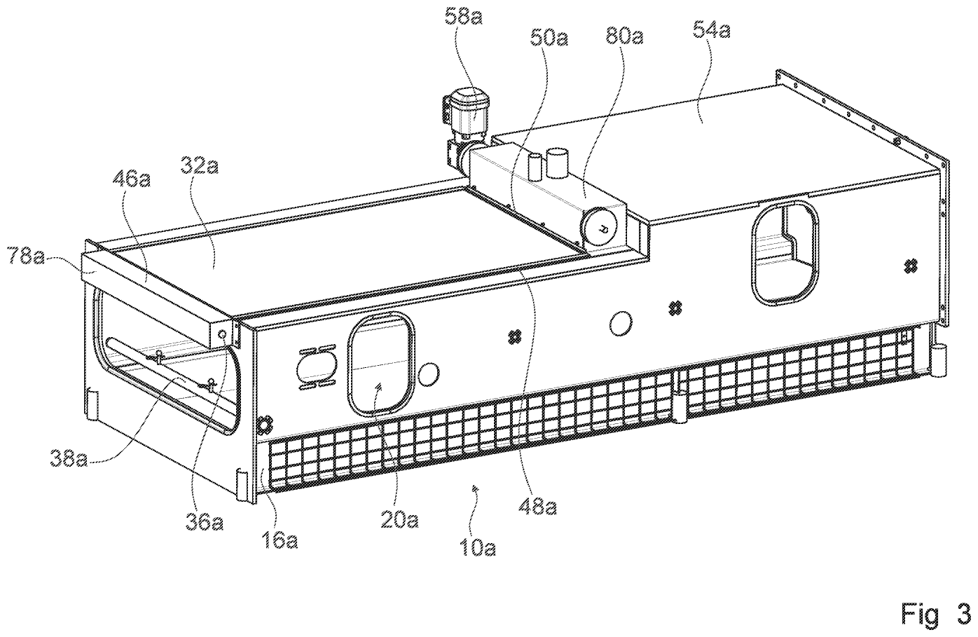

FIG. 3 shows the portion of the covering device 10a that is shown in FIG. 2, wherein the covering 32a is in the closure position. The covering 32a comprises a closing strip 50a. In at least one operation state of the covering 32a, in particular in the closure position, the closing strip 50a is configured to close the transport opening 52a of the station housing 54a of the filling station 12a, which delimits the filling space 24a.

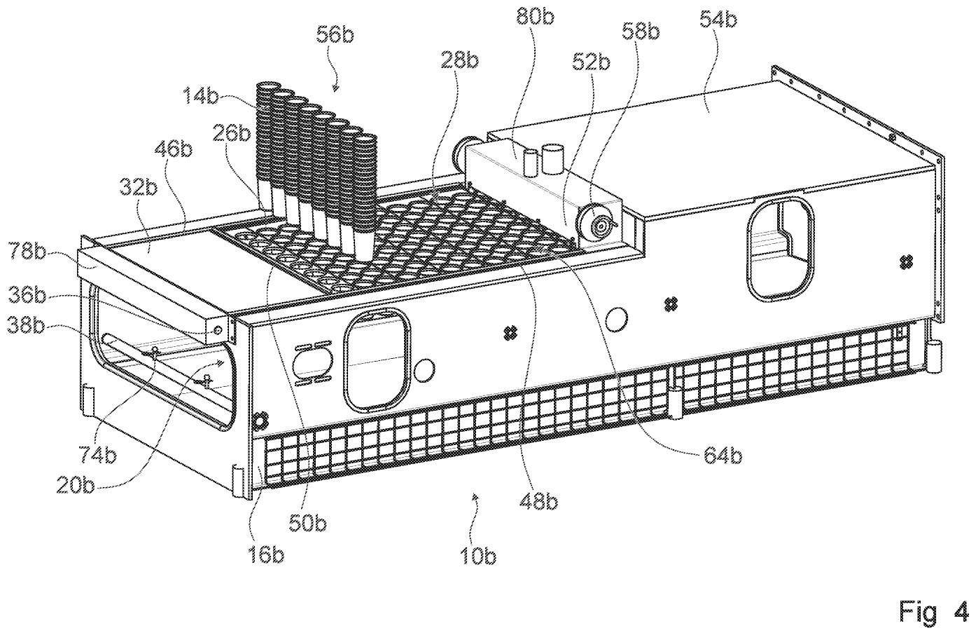

In FIG. 4 a further exemplary embodiment of the invention is shown. The following description and the drawing are essentially limited to the differences between the exemplary embodiments wherein principally, with regard to components having the same denomination, in particular with regard to components having the same reference numerals, the drawings and/or the description of the other exemplary embodiment of FIGS. 1 to 3 may be referred to. In order to distinguish between the exemplary embodiments, the letter a has been added to the reference numerals of the exemplary embodiment in FIGS. 1 to 3. In the exemplary embodiment of FIG. 4 the letter a has been replaced by the letter b.

FIG. 4 shows a covering device 10b for a filling station for a filling of a container 14b. The covering device 10b comprises at least one container transfer housing 16b. The container transfer housing 16b forms an accommodating space 20b. The accommodating space 20b accommodates a container transfer unit 26b of the filling station, which projects from a closed filling space of the filling station. The container transfer housing 16b comprises at least one transfer opening 28b for a passage of the container 14b into the accommodating space 20b of the container transfer housing 16b. The covering device 10b comprises at least one covering 32b, which closes the transfer opening 28b in at least one operation state of the covering 32b. The covering 32b is supported movably at the container transfer housing 16b. The covering device 10b comprises at least one drive unit 58b, which comprises at least one actuation element for a manual movement of the covering 32b. The actuation element is for example embodied as a handwheel.

With regard to further features of the covering device 10b, FIGS. 1 to 3 and their description is referred to.

1. A covering device for a filling station for a filling of a container (14a; 14b), comprising at least one container transfer housing (16a, 18a; 16b) that forms an accommodating space (20a, 22a; 29b) configured to accommodate a container transfer unit (26a; 26b) of the filling station, which projects from a closed filling space (24a) of the filling station, the container transfer housing (16a, 18a; 16b) having at least one transfer opening (28a, 30a; 28b) for a passage of the container (14a; 14b) into and/or out of the accommodating space (20a, 22a; 20b) of the container transfer housing (16a, 18a; 16b), and with at least one covering (32a, 34a; 32b) which closes the transfer opening (28a, 30a; 28b) in at last one operation state of the covering (32a, 34a; 32b), wherein the covering (32a, 34a; 32b) is supported movably at the container transfer housing (16a, 18a; 16b), wherein the covering device further comprises at least one cleaning unit (38a, 40a; 38b), which is arranged within the container transfer housing (16a, 18a; 16b) and is configured, when the transfer opening (28a, 30a; 28b) is closed by the covering (32a, 34a; 32b), for an automated cleaning of the accommodating space (20a, 22a; 20b), wherein the covering device further comprises at least one sensor element (42a, 44a) for a detection of at least one position of the covering (32a, 34a).

2. The covering device according to claim 1, further comprising at least one winding shaft (36a; 36b), which the covering (32a; 32b) is wound on in at least one operation state of the covering (32a; 32b).

3. The covering device according to claim 1, wherein the container transfer housing (16a, 18a; 16b) comprises at least one guide rail (46a, 48a; 46b, 48b) in or on which the covering (32a, 34a; 32b) is arranged.

4. The covering device according to claim 1, wherein the covering (32a, 34a; 32b) comprises a closing strip (50a; 50b) which is configured, in at least one operation state of the covering (32a, 34a; 32b), to close a transport opening (52a; 52b) of a station housing (54a; 54b) of the filling station which delimits the filling space (24a).

5. The covering device according to claim 1, characterized by-further comprising a container repository (56a; 56b) which is arranged outside the container transfer housing (16a, 18a; 16b), for a positioning of the containers (14a; 14b) at the container transfer unit (26a; 26b), wherein the covering (32a, 34a; 32b) is in at least one operation state arranged between the container repository (56a; 56b) and the container transfer housing (16a, 18a; 16b).

6. The covering device according to claim 1, further comprising at least one drive unit (58b), which comprises at least one actuation element for a manual moving of the covering (32b).

7. The covering device according to claim 1, further comprising at least one drive unit (58a, 60a) comprising at least one motor for an automated movement of the covering (32a, 34a).

8. The covering device according to claim 1, characterized by further comprising at least one control or regulation unit (62a), the control or regulation unit (62a) being configured for a temporal coordination of a movement of the covering (32a, 34a; 32b) and an operation and/or a cleaning of the filling station.

9. A filling station for a filling of a container (14a; 14b), with at least one covering device according to claim 1.
